(19) United States
(12) Patent Application Publication
(10) Pub. No.: US 2015/0292915 A1
(43) Pub. Date: Oct. 15, 2015

(54) INFRARED ENCODING OF NON-DESTRUCTIVE EXAMINATIONS

(71) Applicant: Robert W. VIREN, Wilmington, NC (US)

(72) Inventor: Robert W. VIREN, Wilmington, NC (US)

(73) Assignee: GE-HITACHI NUCLEAR ENERGY AMERICAS LLC, Wilmington, NC (US)

(21) Appl. No.: 14/250,468

(22) Filed: Apr. 11, 2014

(51) Int. Cl. G01D 5/347; G01B 11/14

(52) U.S. Cl. CPC G01D 5/347; G01B 11/14

(57) ABSTRACT

An apparatus for encoding examination data of an object includes a sensor and a processor. The sensor is configured to sense a position of a target. The target is attached to an inspection system. The processor is configured to encode examination data of the object. The examination data is obtained from the inspection system. The inspection system obtains the examination data by performing an examination of the object. The processor is configured to perform the encoding by determining position information of the inspection system based on the sensed position of the target, and correlating the position information with the examination data.

### BACKGROUND

Non-destructive examinations (NDE) is a group of analysis techniques used to inspect or otherwise examine one or more properties of a material, substance, component, and/or system without causing damage to the material, substance, component, and/or system being evaluated, inspected, and/or examined. The terms nondestructive testing (NDT), nondestructive inspection (NDI), and nondestructive evaluation (NDEv) are also commonly used to describe NDE. Because NDE does not permanently alter the article being examined, NDE may be a valuable technique for product evaluation, troubleshooting, and/or research.

Common NDE methods include acoustic emission testing (AE), electromagnetic testing (ET), laser testing methods (LM), leak testing (LT), magnetic flux leakage (MFL), liquid penetrant testing (PT), magnetic particle testing (MT), neutron radiographic testing (NR), radiographic testing (RT), thermal/infrared testing (IR), ultrasonic testing (UT), vibration analysis (VA), visual testing (VT), remote visual inspection (RVI), eddy-current testing (ECT), and/or low coherence interferometry (LCI). NDE is commonly used in nuclear engineering, forensic engineering, mechanical engineering, electrical engineering, civil engineering, systems engineering, aeronautical engineering, medicine, and the like.

Materials, components, and/or systems used in industrial settings, such as nuclear power plants (NPPs), are typically required to undergo NDE or other like inspections. NDEs are typically performed by placing an inspection system (or alternatively, a “probe”) on an object to be examined. The probe then transmits an electric current, induces a magnetic field, or transmits ultrasonic waves, and the like into the examination object. A detection system is then used to analyze the electromagnetic radiation, sound waves, or induced magnetic field in view of the inherent properties of the materials and geometry of the examined object. Based on the analysis, examination data is produced. The examination data may be analyzed and/or processed to determine one or more characteristics of the examined object. The characteristics may indicate weld characteristics, a thickness of the object, structural mechanics, and the like. The examination data is then correlated with a position and orientation of the probe. The process of correlating the examination data with the position and/or orientation of the probe may be referred to as “encoding” the examination data. The aforementioned process is then performed multiple times by changing the position and orientation of the probe and probe type. An indication of a deficiency (e.g., a crack, a fracture, and the like), including a position and orientation and approximate size of the deficiency (e.g., whether the crack or fracture is perpendicular or parallel to a weld), may be determined once a sufficient amount of examination data has been encoded.

An NDE and analysis may be performed manually (i.e., “manual examination”) or automatically (i.e., “automatic examination”). Manual examination typically requires a human operator to position and orient the probe on the examination object, while simultaneously analyzing the data produced. When a possible indication is observed, the operator will make physical marks in the inspection area to approximate size and orientation. These data will then be transcribed typically to paper, or in some cases single data points will be saved, but they may not be encoded. However, successful and consistent application of manual examination depends heavily on operator training, experience, and integrity. Additionally, operators involved in manual examination and analysis must undertake numerous training and/or certification courses in order to conduct a proper manual examination. Furthermore, because manual examination requires a human operator to properly place a probe on an object and properly change the position and orientation of the probe, human error in handling the probe may adversely affect the quality and accuracy of the encoded examination data.

Automatic examinations are examinations that are performed by one or more electro-mechanical machines. During automatic examination, an electro-mechanical machine may be incorporated into an inspection system and/or probe, and the electro-mechanical machine may perform similar positioning and orienting functions as a human operator would during a manual examination. Such electro-mechanical machines typically include a positioning and/or orientation detection device, such as an encoder wheel, which allows an operator to determine a position and/or orientation of the probe However, these electro-mechanical machines may require complex arrangements of machinery, tracks, and/or propulsion systems in order to change a position and/or orientation of the probe. For example, a probe incorporating an electro-mechanical machine may require a specialized track to be built on an examination object. By way of another example, propulsion device, such as a water thruster, may be required where the object is in an underwater environment. Building complex arrangements of machinery, tracks, and/or propulsion systems may require extensive planning and may be time consuming and expensive.

Thus, there exists a demand to provide encoding of examinations without costly and/or customized machinery. There also exists a demand to provide accurate encoding of Examinations on objects having a complex geometry and which cover large areas.

### SUMMARY

At least one example embodiment relates to an apparatus for encoding examination data of an object.

In one example embodiment an apparatus for encoding examination data of an object includes a sensor and a processor. The sensor is configured to sense a position of a target. The target may be attached to an inspection system. The processor is configured to encode examination data of the object. The examination data may be obtained from the inspection system. The inspection system may obtain the examination data by performing an examination of the object. The processor is configured to perform the encoding by determining position information of the inspection system based on the sensed position of the target, and correlating the position information with the examination data.

Example embodiments provide that sensor is further configured to sense an orientation of the target, and the processor is further configured to perform the encoding by determining orientation information of the inspection system based on the sensed orientation of the target, and correlating the orientation information with the examination data.

Example embodiments provide that the processor is further configured to perform the encoding by determining a starting position of the inspection system based on a desired three-dimensional (3D) plane, the 3D plane is based on at least one criterion of the object, and defining an origin point for performing the examination of the object based on the starting position. The origin point may a first examination point. The first examination point may be a first position at which the inspection system obtains the examination data.

Example embodiments provide that the processor is configured to determine the starting point by scanning a desired portion of the object, defining a plane based on scanned portion, and determining an axis of the starting position based on the plane.

Example embodiments provide that the processor is configured to scan the desired portion by scanning at least three points on the object.

Example embodiments provide that the processor is further configured to perform the encoding by determining the first examination point based on the starting position, and a distance between the target and a portion of the inspection system where the first examination data is being obtained while the inspection system is in the starting position. The processor is further configured to perform the encoding by correlating a first position of the first examination point with the obtained first examination data.

Example embodiments provide that the processor is further configured to perform the encoding by determining a change in a position of the inspection system due to the inspection system being placed in a second position. The second position may be a different position than the starting position.

Example embodiments provide that the processor is further configured to perform the encoding by determining a second examination point based on the second position, and a distance between the target and the portion of the inspection system where the second examination data is being obtained while the inspection system is in the second position. The processor is further configured to perform the encoding by correlating a second position of the second examination point with the obtained second examination data.

Example embodiments provide that the target includes at least three markers, the 3D plane is defined using the at least three markers, and the sensor is a camera system that includes at least two cameras. Example embodiments provide that defining the origin point is further based at least one point of the 3D plane, and that determining the examination point is based on a distance between at least one marker of the at least three markers and the portion of the inspection system where the examination data is being obtained.

Example embodiments provide that the examination data is obtained by performing at least one of an ultrasonic testing, an eddy current testing, and a phased array testing; and the at least two cameras are infrared cameras.

Example embodiments provide that the processor is further configured to perform the encoding by determining whether a deficiency in the object exists based on the examination data. If the deficiency is determined to exist, a position of the deficiency is determined based on the position information, and the position of the deficiency is correlated with the examination data used for determining that the deficiency in the object exists.

At least one example embodiment relates to a method of encoding examination data of an object.

In one example embodiment a method of encoding examination data of an object is provided. The method includes sensing a position of a target, the target being attached to an inspection system. The method includes receiving examination data of the object. The examination data may be obtained from the inspection system. The inspection system may obtain the examination data by performing an examination of the object. The method includes encoding examination data. The encoding includes determining position information of the inspection system based on the position of the target, and correlating the position information with the examination data.

Example embodiments provide that the method further includes sensing an orientation of the target, and that the encoding further includes determining orientation information of the inspection system based on the sensed orientation of the target, and correlating the orientation information with the examination data.

Example embodiments provide that the encoding further includes determining a starting position of the inspection system based on a desired three-dimensional (3D) plane, where the 3D plane is based on at least one criterion of the object, and defining an origin point for performing the examination of the object based on the starting position, the origin point being a first examination point, the first examination point being a first position at which the inspection system obtains the examination data.

Example embodiments provide that determining the starting position includes scanning a desired portion of the object, defining a plane based on scanned portion, and determining an axis of the starting position based on the plane.

Example embodiments provide that scanning the desired portion further includes scanning at least three points on the object.

Example embodiments provide that the encoding further includes determining the first examination point based on the starting position, and a distance between the target and a portion of the inspection system where the first examination data is being obtained while the inspection system is in the starting position. The encoding further includes correlating a first position of the first examination point with the obtained first examination data.

Example embodiments provide that the encoding further includes determining a change in a position of the inspection system due to the inspection system being placed in a second position, the second position being a different position than the starting position.

Example embodiments provide that the encoding further includes determining a second examination point based on the second position, and a distance between the target and the portion of the inspection system where the examination data is being obtained while the inspection system is in the second position. The encoding further includes correlating a second position of the second examination point with the obtained second examination data

Example embodiments provide that the target includes at least three markers, the 3D plane is defined using the at least three markers, and the sensing is performed by a camera system that includes at least two cameras. Example embodiments provide that defining the origin point is further based on at least one point of the 3D plane, and that determining the examination point is based on a distance between at least one marker of the at least three markers marker and the portion of the inspection system where the examination data is being obtained.

Example embodiments provide that the examination is performed by using at least one of an ultrasonic testing, an eddy current testing, and a phased array testing; and the at least two cameras are infrared cameras.

Example embodiments provide that the encoding further includes determining whether a deficiency in the object exists based on the examination data. If the deficiency is determined to exist, a position of the deficiency is determined based on the position information, and the position of the deficiency is correlated with the examination data used for determining that the deficiency in the object exists.

At least one example embodiment relates to an inspection system for performing an examination of an object and generating examination data to be encoded.

In one example embodiment the inspection system includes a transducer configured to perform the examination of the object. The inspection system includes a transceiver configured to transmit the examination data. The examination data may be based on the performed examination. The inspection system includes a target attached to the inspection system. A position of the target may be sensed by a camera system. The camera system may be associated with a computing system. The computing system may be configured to encode the examination data by determining position information of the inspection system based on the sensed position of the target, and correlating the position information with the examination data.

At least one example embodiment relates to a system for encoding examination data of an object.

In one example embodiment the system for encoding examination data of an object includes an inspection system including a target attached to the inspection system. The inspection system may be configured to perform an examination of the object, and transmit examination data, the examination data being based on the performed examination. The system for encoding examination data of an object includes a computing system including a camera system and a processor. The camera system may be configured to sense a position of the target. The processor may be configured to encode the examination data by determining position information of the inspection system based on the sensed position of the target, and correlating the position information with the examination data.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIGS. 1A-1C illustrate a system for encoding examination data of an object, according to an example embodiment;

FIG. 2 illustrates the components of an origin definition tool that is employed by the system for encoding examination data of an object of FIGS. 1A-C, according to an example embodiment;

FIG. 3 illustrates the components of an inspection system that is employed by the system for encoding examination data of an object of FIGS. 1A-C, according to an example embodiment;

FIG. 4 illustrates the components of an computing system that is employed by the system for encoding examination data of an object of FIGS. 1A-C, according to an example embodiment; and

FIG. 5 illustrates an examination data encoding routine, according to an example embodiment.

### DETAILED DESCRIPTION OF EMBODIMENTS

Various example embodiments will now be described more fully with reference to the accompanying drawings in which some example embodiments of the invention are shown.

Detailed illustrative embodiments are disclosed herein. However, specific structural and functional details disclosed herein are merely representative for purposes of describing example embodiments of the present invention. This invention may, however, may be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, wireless channels, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Example embodiments are discussed herein as being implemented in a suitable computing environment. Although not required, example embodiments will be described in the general context of computer-executable instructions, such as program modules or functional processes, being executed by one or more computer processors or CPUs. Generally, program modules or functional processes include routines, programs, objects, components, data structures, etc. that performs particular tasks or implement particular data types. The program modules and functional processes discussed herein may be implemented using existing hardware in existing communication networks. For example, program modules and functional processes discussed herein may be implemented using existing hardware at existing network elements or control nodes. Such existing hardware may include one or more digital signal processors (DSPs), application-specific-integrated-circuits, field programmable gate arrays (FPGAs) computers or the like.

The example embodiments of encoding examination data of an object allow for examination encoding to occur with little or no complex arrangements of machinery, tracks, and resolvers to determine an inspection system and/or probe position. The application of specialized sensors (e.g., infrared cameras), reflective targets and/or markers, specialized target and/or marker fixture, and a computing system allows for the encoding of Examinations with less reliance on costly setups, customized tracks, and/or customized hardware. The example embodiments also allow for Examinations to be performed on objects having complex geometry and/or objects covering large areas.

The example embodiments integrate inspection system data with at least sub-millimeter accurate position information and/or orientation information streamed from the sensor. The inspection system data may be procured by way of ultrasonic testing, an eddy current testing, phased array testing, and the like. The synchronization and capture of this data produces a data stream similar to traditional methods of examination data encoding without the physical constraints of bulky hardware and/or other the other traditional Examination setups.

As used herein, the term “position” may refer to a location or point that one object may be in relation to another object. For example, position information may indicate a point that an inspection system is located on an examination object in a two-dimensional (2D) or three-dimensional (3D) space. As used herein, the term “orientation” may refer to a placement of an object in relation to another object. For example, orientation information may indicate an angle at which an inspection system is placed in relation to an object that is undergoing an Examination. Together, the position information and the orientation information may indicate how an object is placed in a defined 2D or 3D space. Furthermore, the term “encode”, “encoding”, and the like, as used herein, may refer to a process of correlating examination data with position information and/or orientation information, or otherwise defining a relationship between examination data and position information and/or orientation information.

It should be noted that, although the example embodiments may apply to nuclear safety related systems, the example embodiments may also apply to any industry where the examination one or more materials, components, and/or other like objects are desired. Such industries may include nuclear engineering, forensic engineering, mechanical engineering, electrical engineering, civil engineering, systems engineering, aeronautical engineering, medicine, and/or any other like disciplines that deal with design, construction, and/or maintenance of physical structures.

Example embodiments include a sensor (or a system and/or arrangement of multiple sensors) aimed at one or more targets and/or markers that are attached to an inspection system (or alternatively a “probe”), such that the sensor can see or otherwise sense the one or more targets and/or markers attached to the inspection system. The sensor may be positioned and/or oriented relative to the inspection system such that the inspection system may be sensed by the sensor. The inspection system may include a fixture and/or attachment surface that may be used to attach the inspection system to an object for performing an examination on the object. The fixture may be customized to fit the object based on at least one criterion of the object. Such a criterion of the object may include a geometry and/or shape of the object, a material and/or composition of the object, a position of the object in relation to one or more other objects, a location and/or environment in which the object is located, and/or other like criteria. The fixture may also be configured in such a way that the fixture may properly attach to a housing of the inspection system and/or the one or more targets and/or markers to reduce or otherwise prevent interference with the performance of the examination of the object.

Example embodiments include an inspection system that is capable of transmitting examination data in real-time to a computing system with minimal latency. The examination data may be encoded, correlated, or otherwise matched with position and/or orientation data that is detected by the sensor. A high latency in transmitting the examination data to the computing system may delay or otherwise hinder synchronization between the examination data with the position information and/or orientation information, and may reduce the computing system's ability to properly encode, correlate, or otherwise match the examination data with the position information and/or orientation information.

Example embodiments include a computing system capable of handling and receiving data streams of the examination data, which are received from the inspection system. The computing system may include at least one processor, a computer-readable medium, and/or a receiver (or optionally, a transmitter/receiver combination device, and/or a transceiver). The computing system may also include one or more hardware modules, software modules, or any combination thereof, which may allow the processor of the computing system to determine a position and/or orientation of the inspection system based on information received from the sensor. The information received from the sensor may indicate a position and/or orientation of the one or more targets and/or markers. The computing system may also include one or more hardware modules, software modules, or any combination thereof, which may allow the processor of the computing system to encode, correlate, or otherwise determine a statistical relationship between the determined position and/or orientation of the inspection system with the examination data received from the inspection system.

Example embodiments include an origin definition tool that may be used to define an origin point on the object based on a position and orientation of one or more targets and/or markers of the origin definition tool. The origin definition tool may be configured to remain in a substantially static position for a duration of a origin definition process. Example embodiments also allow for the computing system to determine an origin point without the use of an origin definition tool.

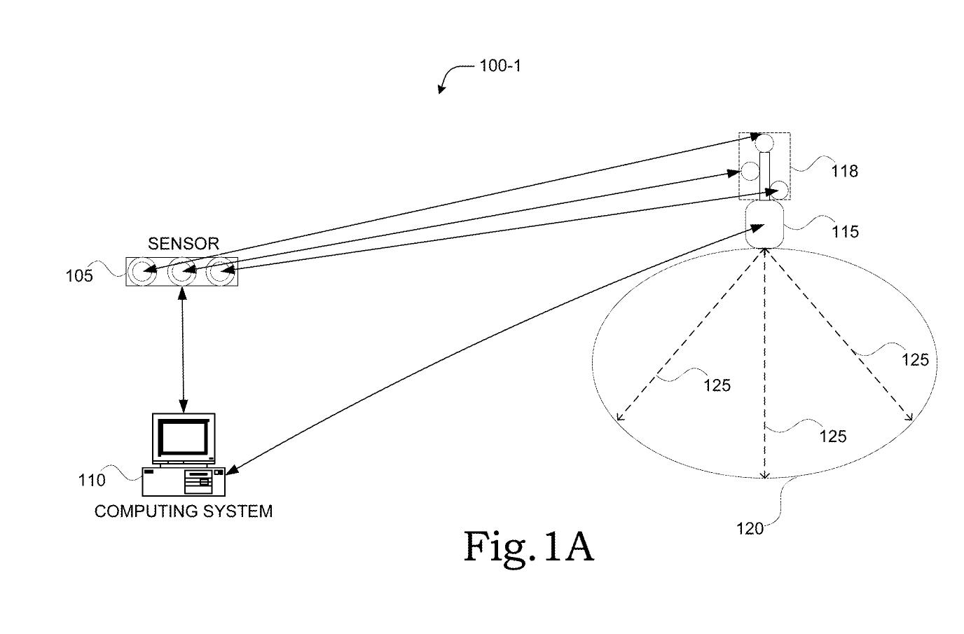

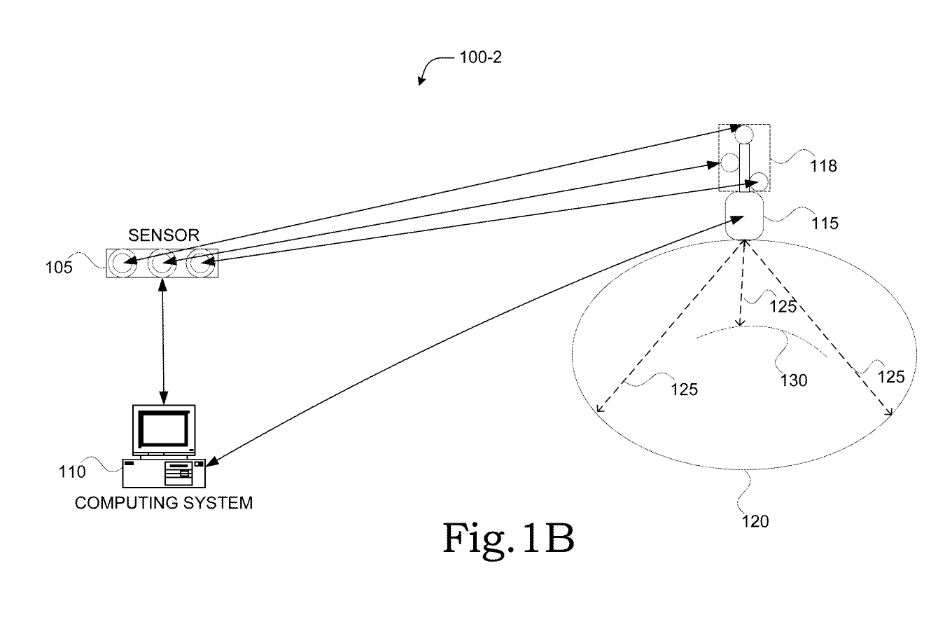

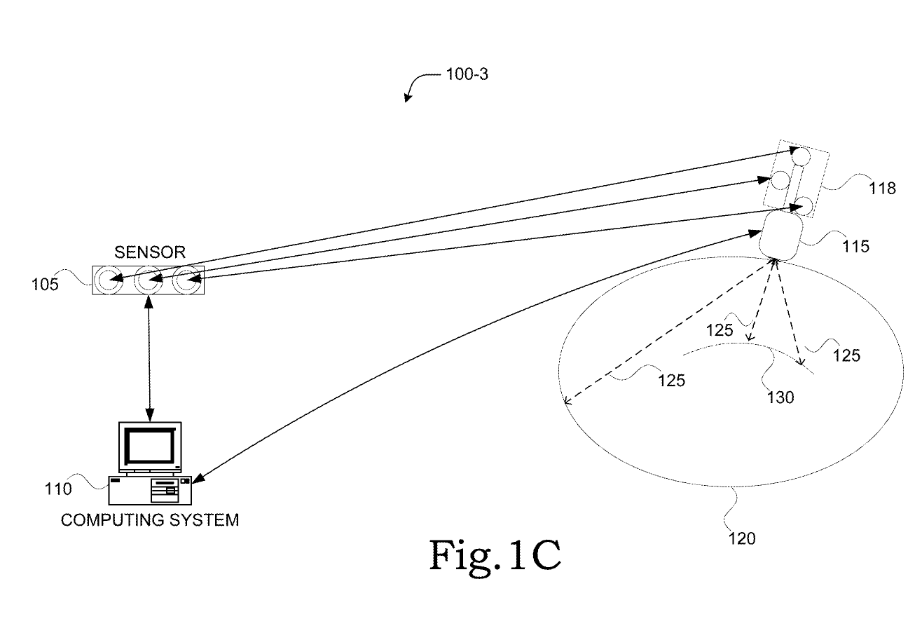

FIGS. 1A-C illustrate an examination data encoding system 100, according to an example embodiment. The examination data encoding system 100 includes sensor 105, computing system 110, inspection system 115, and object 120. Additionally, inspection system 115 includes target 118. FIGS. 1A-C show a representation of a system for encoding examination data of an object.

According to various embodiments, sensor 105 may be any device that senses, detects, captures, measures or otherwise obtains a position and/or an orientation of an object and converts the sensed position and/or orientation into a signal and/or data stream which can be read by a computing device (e.g., computing system 110). In various embodiments, sensor 105 may be configured to record and/or store the sensed position and/or orientation as position information and/or orientation information (or alternatively “orientation data”). Once the position information and/or orientation information is sensed and recorded, such position information and/or orientation information may be reported or otherwise transmitted to a computing system (e.g., computing system 110) to be encoded (i.e., correlated with obtained examination data) and/or stored on a data storage device. Sensor 105 may also be configured to receive data requests and/or control data from one or more computing devices (e.g., computing system 110).

In various embodiments, sensor 105 may include one or more motion capture devices that may be configured to capture motion by detecting a change in position of a body (e.g., inspection system 115) relative to its surroundings (e.g., object 120 and/or other surrounding non-examined objects), or by detecting a change in the surroundings relative to the body. In such embodiments, sensor 105 may be configured to measure the strength and/or speed of a body's motion. In various embodiments, motion may be detected by sound, opacity, geomagnetism, reflection of transmitted energy, electromagnetic induction, vibration, and/or other like means of detecting motion.

In various embodiments, sensor 105 may include one or more thermographic cameras and/or infrared cameras, which may be configured to form images using infrared radiation. Such infrared cameras may be similar to optical-lens cameras, which form images using visible light (i.e., 450-750 nanometer (“nm”) wavelength range), but instead operate in wavelengths in the infrared range of the electromagnetic spectrum (i.e., 700 nm-1 millimeter (“mm”)). In embodiments where sensor 105 includes one or more infrared cameras, sensor 105 may also include an infrared projector and/or infrared laser projector, which may be configured to project an infrared beam at one or more targets and/or markers (e.g., target 118 and/or the markers of target 118) attached or otherwise associated with an inspection system (e.g., inspection system 115). The one or more infrared cameras may be configured to sense a reflection of the infrared beam being reflected off the one or more targets and/or markers (e.g., target 118 and/or the markers of target 118) attached to an inspection system (e.g., inspection system 115).

In various embodiments, sensor 105 may also include a network interface configured to connect sensor 105 to one or more other hardware computing devices (e.g., computing system 110) wirelessly via a transmitter and a receiver (or optionally a transceiver) and/or via a wired connection using a communications port. Sensor 105 may be configured to send/receive data to/from one or more other hardware computing devices (e.g., computing system 110), and/or network devices, such as a router, switch, or other like network devices, via the network interface using the wired connection and/or the wireless connection. The wireless transmitter/receiver and/or transceiver may be configured to operate in accordance with the IEEE 802.11-2007 standard (802.11), the Bluetooth standard, and/or any other like wireless standards. The communications port may be configured to operate in accordance with a wired communications protocol, such as a serial communications protocol (e.g., the Universal Serial Bus (USB), FireWire, Serial Digital Interface (SDI), and/or other like serial communications protocols), a parallel communications protocol (e.g., IEEE 1284, Computer Automated Measurement And Control (CAMAC), and/or other like parallel communications protocols), and/or a network communications protocol (e.g., Ethernet, token ring, Fiber Distributed Data Interface (FDDI), and/or other like network communications protocols).

According to various embodiments, computing system 110 is a physical hardware computing device capable of communicating with a one or more other hardware computing devices (e.g., sensor 105, inspection system 115, one or more associated databases (not shown), and the like) via a communications interface, such that computing system 110 is able to receive one or more signals and/or data streams from the other hardware computing devices. Computing system 110 may include memory and one or more processors. Computing system 110 may be designed to sequentially and automatically carry out a sequence of arithmetic or logical operations; equipped to record/store digital data on a machine readable medium; and transmit and receive digital data via one or more network devices. Computing system 110 may include devices such as desktop computers, laptop computers, a mobile terminal (e.g., tablet personal computers and the like), and/or any other physical or logical device capable of recording, storing, and/or transferring digital data via a connection to a network device.

In various embodiments, computing system 110 may include a network interface configured to connect computing system 110 to one or more other hardware computing devices (e.g., sensor 105, inspection system 115, one or more associated databases (not shown)) wirelessly via a transmitter and a receiver (or optionally a transceiver) and/or via a wired connection using a communications port. Computing system 110 may be configured to send/receive data to/from one or more other hardware computing devices (e.g., sensor 105, inspection system 115, one or more associated databases (not shown)), and/or network devices, such as a router, switch, or other like network devices, via the network interface using the wired connection and/or the wireless connection. The wireless transmitter/receiver and/or transceiver may be configured to operate in accordance with the IEEE 802.11-2007 standard (802.11), the Bluetooth standard, and/or any other like wireless standards. The communications port may be configured to operate in accordance with a wired communications protocol, such as a serial communications protocol (e.g., the Universal Serial Bus (USB), FireWire, Serial Digital Interface (SDI), and/or other like serial communications protocols), a parallel communications protocol (e.g., IEEE 1284, Computer Automated Measurement And Control (CAMAC), and/or other like parallel communications protocols), and/or a network communications protocol (e.g., Ethernet, token ring, Fiber Distributed Data Interface (FDDI), and/or other like network communications protocols). Computing system 110 may be configured to “encode” or otherwise correlate position and/or orientation information received from one or more sensors (e.g., sensor 105) with examination data received from one or more inspection systems (e.g., inspection system 115).

According to various embodiments, inspection system 115 is a physical computer hardware device capable of performing a non-destructive testing (NDE) examination of an object (e.g., object 120). Inspection system 115 may include one or more hardware devices and/or software components configured to transmit one or more signals, such as ultrasonic pulse-waves, one or more types of electromagnetic radiation waves, a magnetic field, a eddy-currents, and/or the like (e.g., signals 125) into an object (e.g., object 120). Inspection system 115 may be configured to detect, measure, and/or analyze an energy level of the signals penetrating the examination object in order to determine one or more characteristics of the examination object. The determined characteristics may indicate an internal flaw and/or deficiency, a thickness of the object, and the like.

In various embodiments, inspection system 115 may include a transducer or any other like device that is configured to convert a signal in one form of energy to another form of energy (not shown). Energy types include (but are not limited to) electrical, electromagnetic (including light), chemical, acoustic, thermal energy, and the like. Such a transducer may include the use of a sensor/detector, where the sensor/detector is configured to detect a parameter in one form and report it in another form of energy. In such embodiments, the reporting form of energy may include an analog signal, a digital data stream, and the like.

In various embodiments, inspection system 115 is a physical computer hardware device capable of communicating with one or more other hardware computing devices (e.g., computing system 110, and the like) via a communications interface. Inspection system 115 may also include a network interface configured to connect inspection system 115 to one or more other hardware computing devices (e.g., computing system 110) wirelessly via a transmitter and a receiver (or optionally a transceiver) and/or via a wired connection using a communications port. Inspection system 115 may be configured to send/receive data to/from one or more other hardware computing devices (e.g., computing system 110), and/or network devices, such as a router, switch, or other like network devices, via the network interface using the wired connection and/or the wireless connection. The wireless transmitter/receiver and/or transceiver may be configured to operate in accordance with the IEEE 802.11-2007 standard (802.11), the Bluetooth standard, and/or any other like wireless standards. The communications port may be configured to operate in accordance with a wired communications protocol, such as a serial communications protocol (e.g., the Universal Serial Bus (USB), FireWire, Serial Digital Interface (SDI), and/or other like serial communications protocols), a parallel communications protocol (e.g., IEEE 1284, Computer Automated Measurement And Control (CAMAC), and/or other like parallel communications protocols), and/or a network communications protocol (e.g., Ethernet, token ring, Fiber Distributed Data Interface (FDDI), and/or other like network communications protocols). The inspection system 115 may be configured to transmit or otherwise communicate the generated examination data to the one or more other hardware computing devices (e.g., computing system 110, and the like) via the network interface.

In some embodiments, inspection system 115 may include memory, one or more processors, and/or other like hardware components. In such embodiments, the inspection system 115 may be configured to generate examination data based on the detected, measured, and/or analyzed energy level of the signals penetrating the object, and transmit the examination data to a computing device (e.g., computing system 110) to be encoded.

In various embodiments, inspection system 115 may include an accelerometer, gyroscope, gravimeter, and/or another like device that is configured to measure and/or detect an acceleration and/or motion of the inspection system 115. In such embodiments, the inspection system may be configured to determine a magnitude and direction of an acceleration and/or motion of the inspection system 115, and convert the acceleration and/or motion of the inspection system 115 into position and/or orientation information, which may then be transmitted to a computing device (e.g., computing system 110). In such embodiments, the computing device (e.g., computing system 110) may not require a separate sensor (e.g., sensor 105) to obtain position and/or orientation information from the inspection system 115.

In various embodiments, the inspection system 115 may include one or more electro-mechanical components which allow the inspection system 115 to change its position and/or orientation. These electro-mechanical components may include one or more motors, wheels, thrusters, propellers, claws, claps, hooks, and/or other like propulsion components. The inspection system 115 may be configured to change its position and/or orientation based on a desired (or alternatively “predetermined”) trajectory. Such a trajectory may be determined or otherwise defined by a human operator who determines where and how the inspection system 115 is to reach various positions and/or orientations. In some embodiments, the inspection system may include an autonomous position and/or orientation changing mechanism, which allows the inspection system 115 to change its current position and/or orientation based on knowledge of its current position and/or current orientation. Knowledge of the current position and/or current orientation may be calculated by one or more sensors such motor encoders, vision, stereopsis, lasers, and/or global positioning systems (GPS). Knowledge of the current position and/or current orientation may also be transmitted to the inspection system 115 by the computing system 110, where the computing system 110 may determine the current position and/or current orientation of the inspection system 115 based on a current position and/or current orientation of the target 118.

Inspection system 115 includes target 118. In various embodiments, inspection system 115 may be configured to communicate a position and/or orientation of the inspection system 115 by reflecting visual light and/or infrared radiation off of target 118 to one or more sensors (e.g., sensor 105).

According to various embodiments, target 118 may be any affixed or impressed article that serves to identify and/or indicate a position and/or orientation of inspection system 115. In various embodiments, target 118 may include one or more reflective materials and/or components that reflect visual light and/or infrared radiation, which may then be sensed by one or more sensors (e.g., sensor 105). In some embodiments, target 118 may include one or more light-emitting diodes (LEDs), which may emit light that may be sensed by sensor 105. In other embodiments, target 118 may include any device which emits electromagnetic waves which may be sensed by sensor 105. As shown in FIGS. 1A-C, target 118 includes three markers that are circular and/or spherical in shape. However, according to various embodiments, any number of markers may be present. Additionally, in various embodiments, target 118 may include markers that are formed into any shape and/or color. It should also be noted that, although in FIGS. 1A-C show the three markers having a same or similar shape, in various embodiments, each of the markers may be formed into a different shape and/or color from one another.

As shown in FIGS. 1A-1C, sensor 105 includes three cameras each of which corresponds to all of the three markers of target 118. The three markers have a known fixed position in relation to the inspection system 115, and each of the targets may represent a coordinate in a three-dimensional (3D) space. Each one of the cameras may be used to focus on the markers, and as the inspection system 115 moves, each one of the cameras may detector otherwise sense the position of the target as it moves with the inspection system 115. The positions and/or orientations of each corresponding marker may then be used to determine 3D coordinates of the inspection system 115 to be correlated with examination data collected by the inspection system 115. It should also be noted that, although FIGS. 1n various embodiments, sensor 105 may include any number of sensing devices and a target 118 that may include any number of targets and/or markers.

According to various embodiments, object 120 may be any material, component, and/or system that may undergo an examination. For example, object 120 may be a pipe, an engine or frame, an airframe, a spaceframe, propeller, pressure vessel, storage tank, a boiler, a heat exchanger, a turbine bore, in-plant piping, inspection equipment, tubing material, a rail, a beam, and/or one or more components thereof. Object 120 may be made of one or more natural and/or synthetic materials. Additionally, object 120 may include one or more components that are welded together. Object 120 may be associated with one or more American Society of Mechanical Engineers (ASME) code and/or standard. ASME codes include a set of technical definitions and guidelines that address safety, design, construction, installation, operation, inspection, testing, maintenance, alteration, and repair of various components in a mechanical system. In various embodiments, one or more ASME codes associated with object 120 may be used by the inspection system 115 to determine a desired examination protocol, including a signal strength required for performing an examination.

As shown in FIGS. 1A-C, only one sensor 105, and computing system 110, and one inspection system 115 are present. However, according to various embodiments, any number of sensors, computing systems, and/or inspection systems may be present. Additionally, in various embodiments, sensor 105 and computing system 110 be networked devices or they may be provided as a single device.

According to various embodiments, the devices shown in FIGS. 1A-C may interact as follows.

Referring to FIG. 1A, a starting position for the inspection system 115 to be placed on object 120 is determined in order to begin an examination of object 120. A first position in which inspection system 115 is placed on object 120 prior to obtaining examination data may be referred to as the “starting position”. The starting position may be based on any chosen position and/or orientation of the inspection system 115 and/or one or more characteristics of the object 120. In various embodiments, the starting position may be based on a desired origin point, for example, when the current Examination is a replication and/or duplication of an earlier conducted Examination. The origin point may be a first point on object 120 from which examination data is obtained by the inspection system 115. It should be noted that other points from which examination data is obtained by the inspection system 115 may be referred to as “examination points” and the origin point may also be referred to as a “first examination point”.

When conducting Examinations, a starting position of an inspection system may be used as a reference for determining an origin point. An origin point is defined in order produce consistent and/or comparable data sets when multiple Examinations are conducted on a given object. Thus, a determining a starting position may be useful for defining an origin point in order to properly correlate the examination data with the position and/or orientation of the inspection system 115. In typical Examination protocols (e.g., manual examinations and/or automatic examinations), a human operator may make various measurements and computations in order to determine a starting position and/or an origin point. However, when replicating and/or duplicating an examination, human error in determining a starting position and/or an origin point may result in less consistent and/or less comparable data sets when multiple Examinations are conducted on a given object.

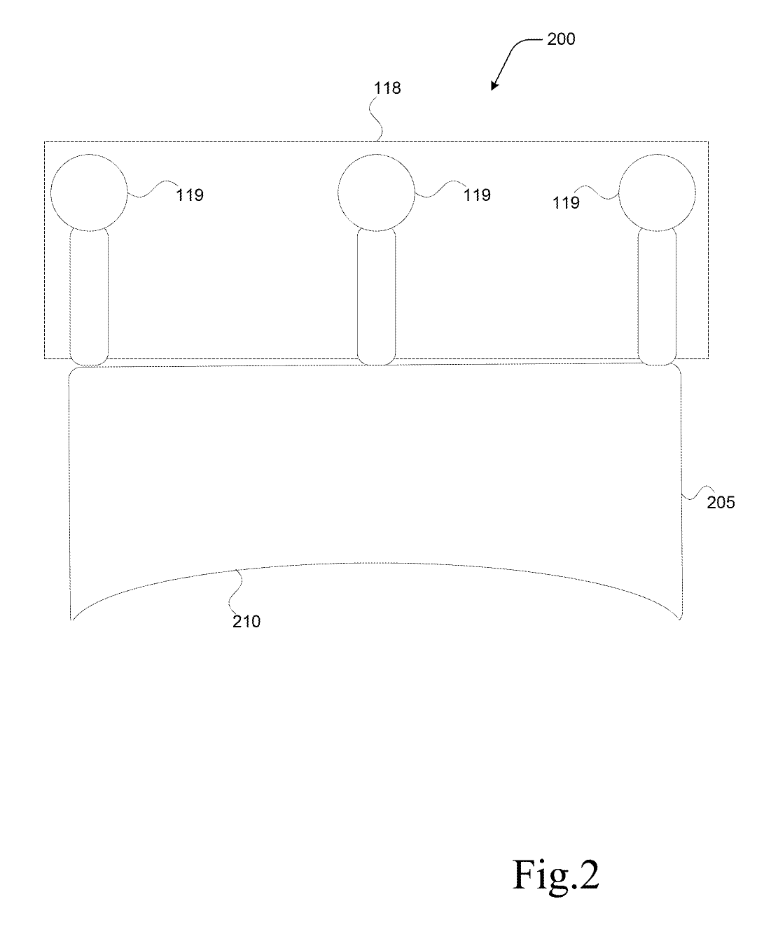

In various embodiments, an origin definition tool (e.g., origin definition tool 200 as shown in FIG. 2) may be used to determine an origin point for a conducting an examination (not shown). In such embodiments, the origin definition tool may be placed in a known configuration on a surface of the object 120 (not shown). The origin definition tool may include three or more markers and/or one or more targets that may be sensed or otherwise detected by sensor 105. The three or more markers and/or one or more targets may be the same or similar to the target 118 as described above. The sensor 105 may then be used by computing system 110 to detect the origin definition tool, and the computing system 110 may define the origin point based on the detected origin definition tool. The origin point may be adjusted based on the geometry of the object 120 (i.e., a size, shape, circumference, radii, diameter, and the like), one or more materials used in the construction and/or manufacture of the object 120, a position and/or orientation of the object 120, an environment in which the object 120 is located, and/or other like criterion. It should be noted that, in embodiments where only position information is obtained, the origin definition tool may only include one marker and/or target.

For example, based on one or more criteria of the object 120, the origin definition tool may be placed in a desired starting position on the object 120. The origin definition tool may include three markers. The three markers may have a known position in relation to one another and/or in relation to a housing of the origin definition tool. The position of the three markers may represent three coordinates of a discrete three-dimensional (3D) plane in a 3D coordinate system. Once the 3D coordinates of the 3D plane are determined based on the three markers of the origin definition tool, the computing system 110 may determine an origin point of the 3D plane. In some embodiments, because the three markers are each in a known position in relation to the origin definition tool, a defined 3D plane may be derived allowing for the creation and/or definition of an origin point and one or more axes for defining other points in the 3D plane. In various embodiments, the portion of inspection system 115 which conducts the examination may be a transducer and/or any other like device that converts a signal in one form of energy to another form of energy. Once the origin point is determined, the origin definition tool is replaced with the inspection system 115 in order to begin the examination of the object 115. That is, the inspection system 115 is placed in the starting position once the origin point is determined using the origin definition tool. The origin point may be recorded by the computing system 110 in order to make the placement of the inspection system 115 repeatable for future examinations (i.e., replicated and/or duplicated examinations) of object 120.

In other embodiments, a starting position and/or an origin point may be determined without the use of an origin definition tool. In such embodiments, the sensor 105 may be used by computing system 110 to define the origin point based on a chosen and/or desired two-dimensional (2D) or 3D plane on the object 120. The computing system 110 may determine the starting position by scanning a desired portion of the object 120, defining a plane based on scanned portion, and determining the starting position based on the scanned portion of the plane. In various embodiments, the plane may be defined using at least three points on the desired portion of the object 120. Scanning the desired portion of the object 120 may be based on one or more criteria of the object, such as a geometry of the object 120 (i.e., a size, shape, circumference, radii, diameter, and the like), one or more materials used in the construction and/or manufacture of the object 120, a position and/or orientation of the object 120, an environment in which the object 120 is located, and/or other like criteria. Once the starting position is determined based on the scanning of the object 120, the inspection system 115 may be placed in the determined starting position, and the origin point and/or the first examination point may be determined. The origin point and/or the first examination point may be obtained by determining a distance between target 118 of inspection system 115 and a portion of inspection system 115 which conducts the examination (e.g., a transducer of inspection system 115). In embodiments where target 118 includes three markers, as shown in FIGS. 1A-1C, the origin point and/or the first examination point may be obtained by determining a distance between a centroid of the markers and the portion of inspection system 115 which conducts the examination. In some embodiments, where target 118 includes three markers, as shown in FIGS. 1A-1C, the origin point and/or the first examination point may be obtained by determining a distance between one of the markers and the portion of inspection system 115 which conducts the examination.

As discussed above, the computing system 110 may determine the starting position by scanning a desired portion of the object 120, defining a plane based on at least three points of the scanned portion, and determining the starting position based on the scanned portion. In various embodiments, the origin point may be defined as a chosen one of the three points of the scanned portion. In such embodiments, the starting position may be determined based on the chosen one of the three points of the scanned portion, such that the placement of the inspection system 115 in the starting position allows for the chosen one of the three points of the scanned portion to be the origin point. In some embodiments, the starting position may be defined so that the inspection system 115 may be placed on the object 120 in such a way that the distance between the target 118 and the portion of inspection system 115 which conducts the examination (e.g., a transducer of inspection system 115) is the chosen one of the three points of the scanned portion.

Referring back to FIG. 1A, once a starting position and an origin point are determined, inspection system 115 performs an examination of object 120 by transmitting signals 125 into object 120 and obtaining return or echo signals. In various embodiments, the inspection system 115 may include a sensor, device, and/or other like materials which senses vibrations created by the return or echo signals (e.g., piezoelectric crystal materials, such as gallium phosphate, quartz, tourmaline, Lead Magnesium Niobate-Lead Titanate (PMN-PT), and the like). The inspection system 115 may convert the vibrations created by the return or echo signals into an electrical signal and/or radio signal, which may be transmitted to the computing system 110. The computing system 110 may then use the received signals to determine characteristics of the object 120 and/or a position and/or orientation of an article within the object 120. The computing system 110 may determine the distance to an article within the object 120 based on the known properties of the object 120 (e.g., size, shape, material, and the like) and/or other like criteria. In various embodiments, the computing system 110 may produce, based on the received signal, a waveform or other like visual representation which represents the signals 125 and the return or echo signals moving through object 120.

In some embodiments, the inspection system 115 may include at least one processor and/or a sensor. The processor and/or sensor within the inspection system 115 may calculate a time interval between transmitting the signals 125 and receiving the return or echo signals. The calculated time interval may then be sent to computing system 110 as examination data, where the computing system may determine characteristics of the object 120 based on the calculated time interval.

Referring back to FIG. 1A, signals 125 may penetrate through object 120 without reflecting off any intermediary objects or other like articles. Thus, object 120 depicted in FIG. 1A may not have an indication of a deficiency.

As shown in FIGS. 1A-C, only three signals 125, which penetrate object 120 and return or echo back, are illustrated. However, according to various embodiments, any number of signals 125, and/or types of signals may be present. For example, in various embodiments, the Examination may be performed using eddy currents, where a change in inductance is detected. In such embodiments, the eddy currents may have a different shape and/or form as those illustrated by signals 125 of FIGS. 1A-1C.

Referring back to FIG. 1A, while the examination is being performed by the inspection system 115, sensor 105 senses a position and orientation of target 118, which is affixed or otherwise attached to inspection system 115. Sensor 105 captures and/or records the position and/or orientation of target 118 and sends position and orientation information of the target 118 to computing system 110 via a wired or wireless communication protocol. Computing system 110 determines the position and/or orientation of the target 118 based on the received position and/or orientation information, and determines a position and/or orientation of a point where the examination data is being obtained (i.e., an examination point). Since FIG. 1A depicts the inspection system 115 being placed in the determined starting position, the determined examination point should be substantially the same or substantially equivalent to the origin point and/or the first examination point. Once the examination point is determined, the computing system 110 encodes the examination data by correlating the examination data received from the inspection system 115 with the determined position and orientation of the examination point (i.e., the origin point and/or the first examination point as shown in FIG. 1A).

The system as depicted in FIG. 1B operates in the same fashion as discussed above with respect to FIG. 1A, however, in the example depicted by FIG. 1B, a deficiency 130 may be detected by inspection system 115 via signals 125. In such a case, the computing system 110 encodes the examination data by correlating the examination data received from the inspection system 115, which indicates the detected deficiency 130, with the determined position and/or orientation of the examination point (i.e., the origin point and/or the first examination point).

The system as depicted in FIG. 1C operates in the same fashion as discussed above with respect to FIG. 1B, however, in FIG. 1C the inspection system 115 has been repositioned and/or reoriented, such that inspection system is placed in a second position and/or a second orientation. In such an example, inspection system 115 may perform an examination of object 120 in the second position and/or second orientation, and may detect deficiency 130 via signals 125 in the second position and/or second orientation. Sensor 105 may sense the second position and/or second orientation of the inspection system 115 based on the target 118 being placed in the second position and/or second orientation. Computing system 110 may determine a change in the position and/or orientation of the inspection system 115 based on position information and/or orientation information obtained from sensor 105. Computing system 110 may determine a second examination point based on the second position information and/or second orientation information received from the sensor 105. In various embodiments, computing system 110 may determine the second examination point in the same manner as discussed above with respect to the origin point and/or the first examination point. The computing system 110 encodes the second examination data by correlating the second examination data received from the inspection system 115, which indicates the detected deficiency 130 in the second position and/or second orientation, with the determined position and orientation of the second examination point.

As shown in FIGS. 1B-C, the inspection system 115 is placed in two positions and/or orientations. However, according to various embodiments, the inspection system may be placed in any number of desired positions and/or desired orientations in order to conduct the Examination of object 120. Once the inspection system 115 has been placed in the desired amount of positions and/or the desired amount of orientations, the computing system 110 may determine a position and/or orientation of the deficiency 130 based on the encoded data.

FIG. 2 illustrates the components of an origin definition tool 200 that is employed by the examination data encoding system 100 of an object of FIGS. 1A-C, according to an example embodiment. As shown origin definition tool 200 includes target 118 and housing 205. Target 118 includes markers 119 and housing 205 includes attachment surface 210.

According to various embodiments, target 118 may be the same or similar to target 118 as discussed above with respect to FIGS. 1A-1C, such that target 118 any affixed or impressed article that serves to identify and/or indicate a position and/or orientation of origin definition tool 200. In various embodiments, target 118 may include one or more reflective materials and/or components that reflect visual light and/or infrared radiation, which may then be sensed by one or more sensors (e.g., sensor 105). In such embodiments, the reflective materials may be attached to each of the markers 119. In some embodiments, target 118 may include one or more light-emitting diodes (LEDs), which may emit light that may be sensed by sensor 105. In such embodiments, the LEDS may be attached to, or otherwise included in each of the markers 119. In other embodiments, target 118 may include any device which emits electromagnetic (EM) waves which may be sensed by sensor 105. In such embodiments, the EM wave emitting devices may be attached to, or otherwise included in each of the markers 119. As shown in FIG. 2, target 118 includes three markers 119 that are circular and/or spherical in shape. However, according to various embodiments, any number of targets and/or markers may be present. Additionally, in various embodiments, target 118 may include targets that are formed into any shape and/or color.

According to various embodiments, housing 205 may be any device that is used to physically mount the origin definition tool 200 to an examination object (e.g., object 120) and which is used to physically include one or more components of the origin definition tool 200 (e.g., target 118 and markers 119). Housing 205 may be manufactured out of various materials and/or fibers, including metal, plastic, glass, rubber, ferromagnets, and/or any other like materials that are natural and/or synthetic. Moreover, in various embodiments, housing 205 may be formed into various sizes and/or shapes based on one or more criteria of an examination object, such as a geometry of the examination object (i.e., a size, shape, circumference, radii, diameter, and the like), one or more materials used in the construction and/or manufacture of the examination object, a position and/or orientation of the examination object, an environment in which the examination object is located, and/or other like criterion.

In various embodiments, the origin definition tool 200 includes attachment surface 210. Attachment surface 210 is used to attach or otherwise affix the origin definition tool 200 to a desired portion of an examination object (e.g., object 120). Additionally, attachment surface 210 may be manufactured out of various materials and/or fibers, including metal, plastic, glass, rubber, and/or any other like materials that are natural and/or synthetic. The form and configuration of attachment surface 210 may be based on one or more criteria of an examination object, such as a geometry of the examination object (i.e., a size, shape, circumference, radii, diameter, and the like), one or more materials used in the construction and/or manufacture of the examination object, a position and/or orientation of the examination object, an environment in which the examination object is located, and/or other like criterion. Attachment surface 210 may include one or more attachment components which allow origin definition tool 200 to attach to an examination object. In various embodiments, the one or more attachment components may include a magnetic component (i.e., any material, or combinations of materials, that attracts other permanent magnetic materials and/or any ferromagnetic materials), an adhesive component (i.e., any substance applied to a surface of at least two materials that binds them together and resists separation), and the like. In various embodiments, the one or more one or more attachment components may include one or more implements, such as hooks, clamps, fasteners, and the like.

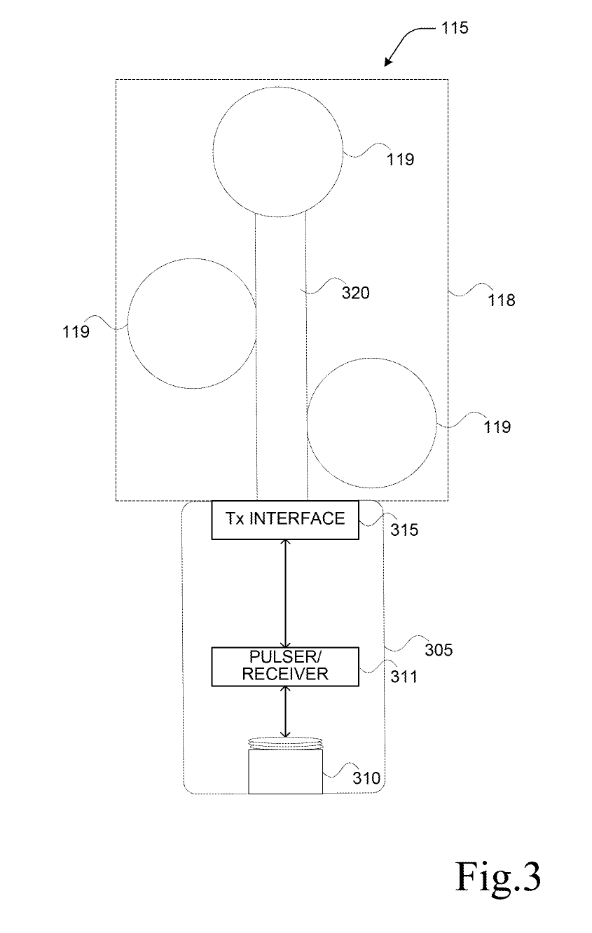

FIG. 3 illustrates the components of an inspection system 115 that is employed by the examination data encoding system 100 of an object of FIGS. 1A-C, according to an example embodiment. As shown, inspection system 115 includes target 118, housing 305, transducer 310, pulser/receiver 311, transmission interface 315, and antenna 320.

According to various embodiments, as discussed above with respect to FIGS. 1A-1C, target 118 may be any affixed or impressed article that serves to identify and/or indicate a position and/or orientation of inspection system 115. In various embodiments, target 118 may include one or more reflective materials and/or components that reflect visual light and/or infrared radiation, which may then be sensed by one or more sensors (e.g., sensor 105). In such embodiments, the reflective materials may be attached to each of the markers 119. In some embodiments, target 118 may include one or more light-emitting diodes (LEDs), which may emit light that may be sensed by sensor 105. In such embodiments, the LEDS may be attached to, or otherwise included in each of the markers 119. In other embodiments, target 118 may include any device which emits electromagnetic (EM) waves which may be sensed by sensor 105. In such embodiments, the EM wave emitting devices may be attached to, or otherwise included in each of the markers 119. As shown in FIG. 3, target 118 includes three markers 119 that are circular and/or spherical in shape. However, according to various embodiments, any number of targets may be present. Additionally, in various embodiments, target 118 may include targets that are formed into any shape and/or color.

According to various embodiments, housing 305 may be any device that is used to physically mount the inspection system 115 to a target (e.g., target 118) and which is used to physically contain or otherwise include one or more components of the inspection system 115 (e.g., target 118 and markers 119, transducer 310, pulser/receiver 311, transmission interface 315, and antenna 320). Housing 305 may be manufactured out of various materials and/or fibers, including metal, plastic, glass, rubber, and/or any other like materials that are natural and/or synthetic. In various embodiments, housing 305 may be formed into various sizes and/or shapes based on one or more criteria of an examination object, such as a geometry of the examination object (i.e., a size, shape, circumference, radii, diameter, and the like), one or more materials used in the construction and/or manufacture of the examination object, a position and/or orientation of the examination object, an environment in which the examination object is located, and/or other like criterion. Furthermore, housing 305 may attach to an examination object by way or a couplant, such as oil, water, or other like couplant material. Using a couplant material may increase an efficiency of an examination by reducing losses in wave energy due to separation between a surface of the housing 305 and the surface of the examination object (e.g., object 120), imperfections, and/or other conditions in a space between the housing 305 and/or the transducer 310.

In some embodiments, housing 305 may attach to an examination object using one or more attachment components (not shown) which allow inspection system 115 to attach to an examination object. In various embodiments, the one or more attachment components may include a magnetic component (i.e., any material, or combinations of materials, that attracts other permanent magnetic materials and/or any ferromagnetic materials), an adhesive component (i.e., any substance applied to a surface of at least two materials that binds them together and resists separation), and the like. In various embodiments, the one or more one or more attachment components may include one or more implements, such as hooks, clamps, fasteners, and the like. In various embodiments, housing 305 may include one or more electro-mechanical components (not shown) which allow the inspection system 115 to change its position and/or orientation. These electro-mechanical components may include one or more motors, wheels, thrusters, propellers, claws, claps, hooks, and/or other like propulsion components.

According to various embodiments, transducer 310 may be any device that converts a signal in one form of energy to another form of energy. Energy types include (but are not limited to) electrical, electromagnetic (including light), chemical, acoustic, thermal energy, and the like. Transducer 310 may include the use of a sensor/detector, where the sensor/detector is used to detect a parameter in one form and report it in another form of energy. In such embodiments, the reporting form of energy may include an analog signal, a digital data stream, and the like. In various embodiments, transducer 310 may generate and transmit signals (e.g., signals 125) into an examination object in a pulse-like fashion, and may receive of the pulsed waves that are reflected back to the inspection system 115. The reflected signals may come from an interface, such as the back wall of the examination object or from an imperfection or deficiency within the object. In various embodiments, transducer 310 may include a sensor, device, and/or other like material which senses vibrations created by the return or echo signals (e.g., piezoelectric crystal materials, such as gallium phosphate, quartz, tourmaline, Lead Magnesium Niobate-Lead Titanate (PMN-PT), and the like). The transducer 310 may convert the vibrations created by the return or echo signals into an electrical signal and/or radio signal, which may be transmitted to the computing system 110. The pulses of signals may be generated in accordance with pulser/receiver 311.

According to various embodiments, pulser/receiver 311 may be any device that may control a timing and strength of energy generated and transmitted by a transducer (e.g., transducer 310). The pulser section of the pulser/receiver 311 may generate electric pulses of controlled energy, which are converted into pulses when applied to transducer 310. Control functions associated with the pulser section of the pulser/receiver 311 include pulse length or damping (i.e., the amount of time the pulse is applied to the transducer), and pulse energy (i.e., the voltage applied to the transducer). In various embodiments, the pulser section of the pulser/receiver 311 may apply a desired amount of voltage to transducer 310 based on one or more criteria of an examination object, such as a geometry and/or shape of the object, a material and/or substance of the object, a position of the object in relation to one or more other objects, a location and/or environment in which the object is located, and/or other like criteria. The receiver section of the pulser/receiver 311 may receive signals produced by the transducer, which represent received or echoed signals, and convert the received or echoed signals produced by the transducer 310 into an analog signal or a digital signal to be transmitted via the transmission interface 315. In various embodiments, receiver section of the pulser/receiver 311 may include a sensor, device, and/or other like material which senses vibrations created by the return or echo signals (e.g., piezoelectric crystal materials, such as gallium phosphate, quartz, tourmaline, Lead Magnesium Niobate-Lead Titanate (PMN-PT), and the like), and converts the sensed vibrations created by the return or echo signals into an electrical signal. In various embodiments, the receiver section of the pulser/receiver 311 may perform signal rectification, filtering, gain and/or signal amplification, and the like.

According to various embodiments, transmission interface 315 may be any electronic device that, with an antenna (e.g., antenna 320) produces radio waves based on a received electrical signal. According to various embodiments, antenna 320 may be any electrical device that receives an oscillating electrical signal and radiates EM waves based on the received oscillating electrical signal. In various embodiments, the transmission interface 315 may include an oscillator (not shown) to generate a radio frequency signal and a modulator (not shown) to add information or data to the generated radio frequency signal. In various embodiments, transmission interface 315 may receive electrical signals from pulser/receiver 311, which represent the received or echoed signals produced by the transducer 310, and convert the electrical signals produced by the transducer 310 into a radio frequency signal to be transmitted to a computing device (e.g., computing system 110) via antenna 320.

It should be noted that, although FIG. 3 shows inspection system 115 including target 118 including three markers 119, one transducer 310, one pulser/receiver 311, one transmission interface 315, and one antenna 320. In various embodiments, inspection system 115 may include any number of markers and/or targets, transducers, pulser/receivers, transmission interfaces, and/or antennas. Additionally, although FIG. 3 shows the three markers 119 attached to antenna 320, in various embodiments, the markers 119 may be attached to any other portion of the inspection system 115. Furthermore, inspection system 115 may include many more components than are shown in FIG. 3, such as one or more processors and/or computer-readable storage devices.

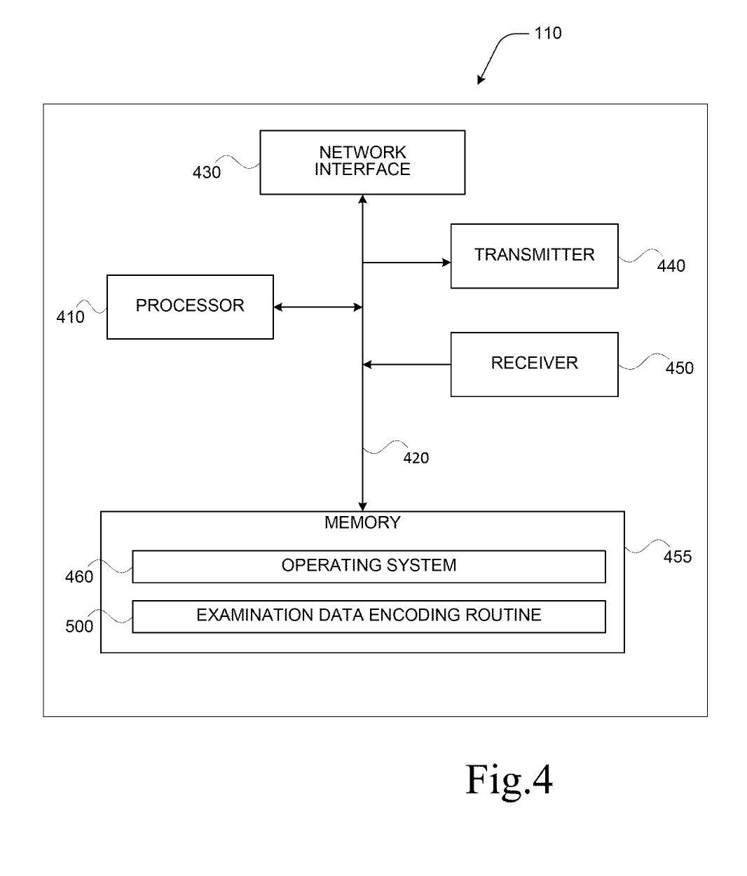

FIG. 4 illustrates the components of a computing system 110 that is employed by the examination data encoding system 100 of an object of FIGS. 1A-C, according to an example embodiment. As shown, computing system 110 includes processor 410, bus 420, network interface 430, receiver 440, transmitter 450, and memory 455. During operation, memory 455 includes operating system 460 and examination data encoding routine 500. In some embodiments computing system 110 may include many more components than those shown in FIG. 4, such as a display device and/or other like input/output devices. However, it is not necessary that all of these generally conventional components be shown in order to disclose the example embodiments.

Memory 455 may be a computer readable storage medium that generally includes a random access memory (RAM), read only memory (ROM), and a permanent mass storage device, such as a disk drive. Memory 455 also stores operating system 460 and examination data encoding routine 500. Additionally, memory 455 may include program code for booting, starting, and/or initializing the computing system 110. These software components may also be loaded from a separate computer readable storage medium into memory 455 using a drive mechanism (not shown). Such separate computer readable storage medium may include a floppy drive, disc, tape, DVD/CD-ROM drive, memory card, thumb drive, and/or other like computer readable storage medium (not shown). In some embodiments, software components may be loaded into memory 455 from a remote data storage device (not shown) via network interface 430, rather than via a computer readable storage medium.

Processor 410 may carry out instructions of a computer program by performing basic arithmetical, logical, and input/output operations of the system. Instructions may be provided to processor 410 by memory 455 via bus 420. Processor 410 is configured to execute program code for examination data encoding routine 500. Such program code may be stored in a storage device (e.g., memory 455).

Bus 420 enables the communication and data transfer between the components of computing system 110. Bus 420 may comprise a high-speed serial bus, parallel bus, storage area network (SAN), and/or other suitable communication technology.

Network interface 430 is a computer hardware component that connects computing system 110 to the other devices in the examination data encoding system 100. Network interface 430 is configured to receive one or more input signals from one or more input devices and output one or more output signals to one or more instruments and/or components. Network interface 430 may connect computing system 110 to other instruments via an optical, wired, and/or wireless connection.

Receiver 440 may be any type of hardware device that can receive and convert a signal from a modulated radio wave into usable information, such as digital data. Receiver 440 may be coupled with an antenna (not shown) in order to capture radio waves. Receiver 440 may be configured to send digital data converted from a captured radio wave to one or more other components of computing system 110 via bus 220.

Transmitter 450 may be any type of hardware device that may generate, or otherwise produce, radio waves in order to communicate with one or more other devices. Transmitter 450 may be coupled with an antenna (not shown) in order to transmit data to one or more other devices. Transmitter 450 may be configured to receive digital data from one or more components of computing system 110 via bus 420, and convert the received digital data into an analog signal for transmission over an air interface. In various embodiments, a transceiver (not shown) may be included with computing system 110. A transceiver may be a single component configured to provide the functionality of transmitter 450 and receiver 440 as discussed above.

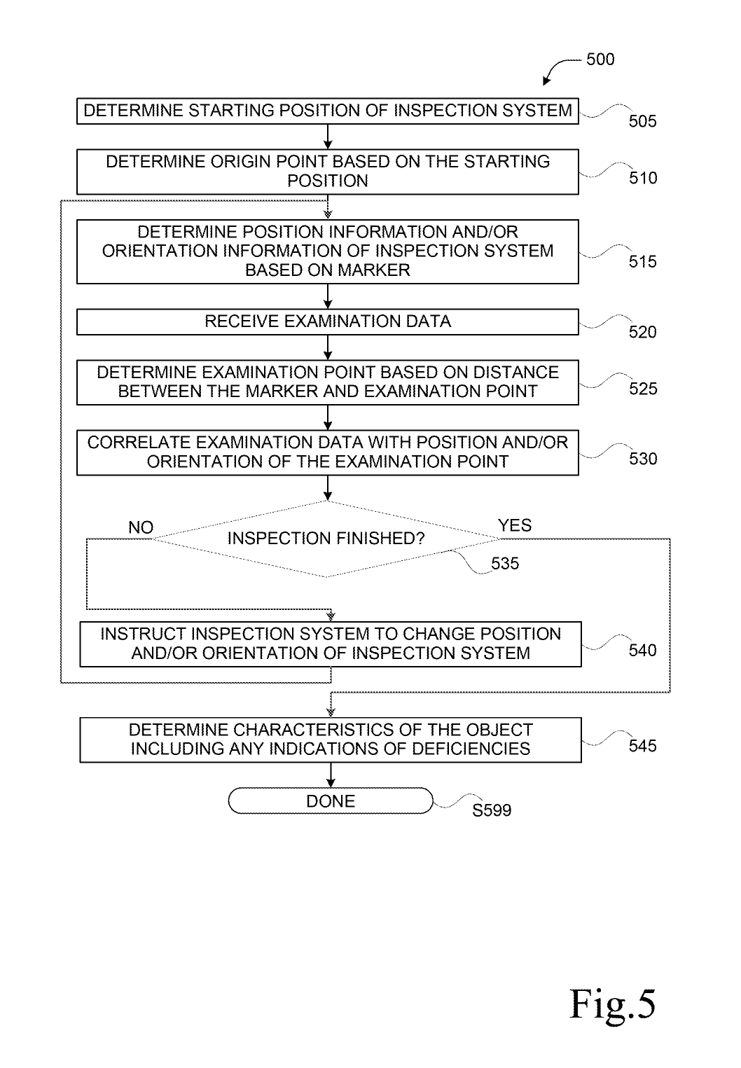

FIG. 5 illustrates an examination data encoding routine 500, according to an example embodiment. examination data encoding routine 500 may be used to encode or otherwise correlate examination data obtained from an inspection system (e.g., inspection system 115) with position information and/or orientation information obtained from one or more sensors (e.g., sensor 105). For illustrative purposes, the operations of examination data encoding routine 500 will be described as being performed by computing system 110 in conjunction the other devices as illustrated in FIGS. 1A-1C. However, it should be noted that any computing device may operate the examination data encoding routine 500 as described below.

Referring to FIG. 5, as shown in operation S505, the computing system 110 determines a starting position of the inspection system 115. The starting position is the first position and/or orientation that the inspection system 115 is placed prior to obtaining examination data. The starting position may be based on a desired origin point or may be any chosen position and/or orientation of the inspection system 115. The starting position and/or origin point may be determined using an origin definition tool such as, origin definition tool 200 as described above with respect to FIGS. 1A and 2. In various embodiments, the starting position and/or an origin point may be determined without the use of an origin definition tool, such as by using the sensor 105 to define the origin point based on a chosen and/or desired 2D or 3D plane on the object 120. The computing system 110 may determine the starting position by scanning a desired portion of the object 120, defining a plane based on scanned portion, and determining the starting position based on the scanned portion of the plane. Scanning the desired portion of the object 120 may be based on one or more criteria of the object, such as a geometry of the object 120 (i.e., a size, shape, circumference, radii, diameter, and the like), one or more materials used in the construction and/or manufacture of the object 120, a position and/or orientation of the object 120, an environment in which the object 120 is located, and/or other like criterion.

As shown in operation 5510, the computing system 110 determines an origin point based on the starting position. The origin point may be a first point on object 120 from which examination data is obtained by the inspection system 115. Once the starting position is determined in operation 5505, the inspection system 115 may be placed in the determined starting position, and the origin point and/or the first examination point may be determined. The origin point and/or the first examination point may be obtained by determining a distance between target 118 of inspection system 115 and a portion of inspection system 115 which conducts the examination (e.g., a transducer 310 of inspection system 115). In embodiments where target 118 includes three markers, as shown in FIGS. 1A-1C and 3, the origin point and/or the first examination point may be obtained by determining a distance between a centroid of the markers and the portion of inspection system 115 which conducts the examination. In some embodiments, where target 118 includes three markers, as shown in FIGS. 1A-1C and 3, the origin point and/or the first examination point may be obtained by determining a distance between one of the markers and the portion of inspection system 115 which conducts the examination.

As shown in operation 5515, the computing system 110 determines position information and/or orientation information of the inspection system 115 based on the target 118. The computing system 110 may use one or more sensors (e.g., sensors 105) to senses, capture, measure, or otherwise obtain position information and/or orientation information of the target 118 based on a position and/or orientation of the target 118. Once the computing system 110 obtains the position information and/or the orientation information of the target 118, the computing system 110 may determine a position and/or orientation of the inspection system 115. As discussed above, the sensor 105 may determine sense position and/or the orientation of the target 118 in relation to one or more surrounding objects. Determining the position and/or orientation of the inspection system 115 may include associating a 2D or 3D coordinate of a defined 2D or 3D space with the sensed position and/or orientation of the target 118 in relation to one or more surrounding objects.

As shown in operations S520, the computing system 110 receives examination data from the inspection system 115. As discussed above, the inspection system 115 may generate and transmit signals (e.g., signals 125) into an examination object (e.g., object 120) in a pulse-like fashion, receive the pulsed waves that are reflected back to the inspection system 115, and transmit the received pulsed waves as a radio signal. In operations S520, the computing system 110 may receive the radio signal generated by the inspection system 115.

As shown in operation S525, the computing system 110 determines an examination point based on a distance between the maker 118 and the examination data point of the inspection system 115. The examination point may be obtained by determining a distance between target 118 of inspection system 115 and a portion of inspection system 115 which conducts the examination (e.g., transducer 310 of inspection system 115). In embodiments where target 118 includes three markers, as shown in FIGS. 1A-1C, the examination point may be obtained by determining a distance between a centroid of the markers and the portion of inspection system 115 which conducts the examination. It should be noted that if a position and/or orientation of the inspection system 115 has not been changed from the starting position, then the examination point should be substantially the same as the origin point and/or the first examination point. In some embodiments, where target 118 includes three markers, as shown in FIGS. 1A-1C, the examination point may be obtained by determining a distance between one of the markers and the portion of inspection system 115 which conducts the examination.

As shown in operation S530, the computing system 110 encodes the examination data by correlating the received examination data with the position and/or orientation of the examination point. Correlating the received examination data with the position and/or orientation of the examination point may include defining a relationship or otherwise associating the received examination data with the position information and/or orientation information. It should be noted that the data streams coming from an inspection system 115 vary depending on connection type. For example, where ultrasonic testing is used, the examination data may be transmitted to the computing system 110 at an adjustable rate of ten bit packets per second, which is translated into numerical characteristic information of the object 120. The computing system 110 may produce or otherwise generate encoded data by time stamping the examination data, and associating the time stamped examination data with the determined position and/or orientation of the examination point. The encoded data may include depth, position information and/or orientation information, and the time to within one ten thousandth of a second based on the adjustable rate of ten bit packets per second. For added functionality the computing system 110 may optionally capture video data and synchronize it to the incoming data examination date, which may act as a validation for the examination data collection process.

In various embodiments, encoding the examination data may include may match and/or synchronize the received examination data with the position and/or orientation of the examination point. Thus, in various embodiments, the computing system 110 may be configured to deal with transmission delay (i.e., “latency”) or other like timing issues in relation to receiving the examination data or the position and/or orientation of the examination point. For example, in various embodiments, the inspection system 115 may be configured to send examination data to the computing system at a rate of 30 data points per second, or a frequency of 30 Hz. However, the sensor 105 may be configured to send position information and/or orientation information at 120 data points per second, or at a frequency 120 Hz. Additionally, transmission delay and/or latency may be caused by interference in data collection and/or interference related to environmental factors. Delay may also build up over time, such that the examination data falls out of sync with the position information and/or orientation information. Thus, excessive delay, if unaccounted for, can render an Examination data set unusable. In such cases, the computing system 110 may be configured to account for the delay and/or latency in data transmission from the inspection system 115 and/or the sensor 105 to the computing system 110.

It should be noted that, occasionally the inspection system 115 may deliver poor data points outside the range of possible values. In some instances, data points outside a range of possible values may occur when the inspection system 115 changes its position and/or orientation, thereby causing the transducer 310 to become detached from the object 120. In various embodiments, the computing system 110 in operation S530 may filter out these data points in order to reduce or otherwise prevent skewed results and/or inaccurate data visualizations. In such embodiments, in order to filter and deliver results without manual data manipulation, the computing system 110 may require input from regarding basic inspection information, such as the expected range of the data of interest, the expected tracking area, and/or the rate of incoming information.

As shown in operation 5535, the computing system 110 determines whether the examination has been completed. If in operations S535 the computing system 110 determines that the examination is not complete, then the computing system 110 proceeds to operation 5540 to instruct the inspection system 115 to change a position and/or orientation of the inspection system 115. If in operations S535 the computing system 110 determines that the examination is complete, then the computing system 110 proceeds to operation 5545 to determine the characteristics of the object 120.

As shown in operations 5540, the computing system 110 instructs the inspection system 115 to change a position and/or orientation of the inspection system 115. In various embodiments, the inspection system 115 may have the capability to move around an environment. In various embodiments, the computing system 110 may instruct or otherwise control the inspection system 115 to change its position based on a desired (or alternatively “predetermined”) trajectory. Such a trajectory may be determined or otherwise defined by a human operator who determines where and how the inspection system 115 is to reach various goals and or waypoints along the way. In some embodiments, the inspection system may include an autonomous position and/or orientation changing mechanism, which allows the inspection system 115 to change its current position and/or orientation based on knowledge of its current position and/or orientation. Knowledge of the current position and/or orientation (i.e., “localization”) may be calculated by one or more sensors such motor encoders, vision, stereopsis, lasers, and/or global positioning systems (GPS). Knowledge of the current position and/or orientation may also be fed to the inspection system 115 by the computing system 110, which is may determine the current position and/or orientation of the inspection system 115 based on the position and/or orientation of the target 118.

Once the computing system 110 instructs the inspection system 115 to change a position and/or orientation of the inspection system 115, the computing system 110 proceeds back to operation S515 to determine position information and/or orientation information of the inspection system 115 based on the target 118.

Referring back to operation S535, if in operations S535 the computing system 110 determines that the examination is complete, then the computing system 110 proceeds to operation S545 to determine characteristics of the object 120 including whether any indications of a deficiency exists in the object 120.

As shown in operations S545, the computing system 110 determines characteristics of the object 120 including whether any indications of a deficiency exists in the object 120. As discussed above, the received examination data is correlated with the position and/or orientation of the examination point by defining a relationship or otherwise associating the received examination data with the position information and/or orientation information. In operation S545, the computing system may produce a visual representation of the encoded examination data. The examination data may be processed based on a testing method used. For ultrasonic testing, the computing system 110 may produce, based on the signal received from the inspection system 115, a waveform or other like visual representation which represents the signals 125 and the return or echo signals moving through object 120. Such a waveform may indicate depth information or other like characteristic information of the examined object. The depth information or other like characteristic information may be plotted against the position and/or orientation information of the examination point. In various embodiments, a cloud of points, which may be colorized to represent depth data, may be used to create a heat map of thin areas and thick areas of the examination object.

As shown in operations S599, the examination data encoding routine 500 ends.

As will be appreciated, the technical effect of the methods and apparatuses according the example embodiments allows for a computer-implemented system to efficiently and accurately perform a nondestructive examination of an object that may have a complex geometry and/or an object that covers a relatively large area, in addition to efficiently and accurately correlating examination data obtained during a nondestructive examination with position information and/or orientation information of an inspection system that obtains the examination data.

As will be appreciated, the methods and apparatuses according the example embodiments have several advantages. First, the example embodiments allow examinations to be performed without costly and/or customized machinery. Second, the example embodiments are cost-effective because the example embodiments provide a more accurate encoding of examinations on objects having a complex geometry and which cover large areas.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. An apparatus for encoding examination data of an metallic object, the apparatus comprising:
a plurality of sensors configured to sense a three-dimensional position of a plurality of targets, the targets being attached to an inspection system; and
a processor configured to encode examination data of the object, the examination data being obtained from the inspection system, the inspection system obtaining the examination data by performing an examination of the object, the examination including translation of the inspection system across the object, and
the processor is configured to perform the encoding by,
determining position information of the inspection system relative to an origin point associated with the object,
the determining including detecting a change in position of the inspection system relative to the origin point using the sensed three-dimensional position of each of the targets, and
correlating the position information with the examination data.

2. The apparatus of claim 1, wherein the sensor is further configured to sense an orientation of the targets, and the processor is further configured to perform the encoding by,
determining orientation information of the inspection system based on the sensed orientation of the targets, and
correlating the orientation information with the examination data.

3. The apparatus of claim 1, wherein the processor is further configured to perform the encoding by,
determining a starting position of the inspection system based on a desired three-dimensional (3D) plane, the 3D plane being based on at least one criterion of the object; and
defining the origin point for performing the examination of the object based on the starting position, the origin point being a first examination point, the first examination point being a first position at which the inspection system obtains the examination data.

4. The apparatus of claim 3, wherein the processor is configured to determine the starting point by,
scanning a desired portion of the object;
defining a plane based on scanned portion; and
determining an axis of the starting position based on the plane.

5. The apparatus of claim 4, wherein the processor is configured to scan the desired portion by,
scanning at least three points on the object.

6. The apparatus of claim 3, wherein the processor is further configured to perform the encoding by,
determining the first examination point based on,
the starting position, and
a distance between the targets and a portion of the inspection system where the first examination data is being obtained while the inspection system is in the starting position; and
correlating a first position of the first examination point with the obtained first examination data.

7. The apparatus of claim 6, wherein the processor is further configured to perform the encoding by,
determining a change in a position of the inspection system due to the inspection system being placed in a second position, the second position being a different position than the starting position.

8. The apparatus of claim 7, wherein the processor is further configured to perform the encoding by,
determining a second examination point based on,
the second position, and
a distance between the targets and the portion of the inspection system where the second examination data is being obtained while the inspection system is in the second position; and
correlating a second position of the second examination point with the obtained second examination data.

9. The apparatus of claim 6, wherein the targets includes at least three markers, the 3D plane is defined using the at least three markers, and the sensors are a camera system that includes at least two cameras, and wherein,
defining the origin point is further based on at least one point of the 3D plane, and
determining the first examination point is based on a distance between at least one marker of the at least three markers and the portion of the inspection system where the examination data is being obtained.

10. The apparatus of claim 9, wherein,
the examination data is obtained by performing at least one of an ultrasonic testing, an eddy current testing, and a phased array testing, and
the at least two cameras are infrared cameras.

11. The apparatus of claim 1, wherein the processor is further configured to perform the encoding by,
determining whether a deficiency in the object exists based on the examination data,
if the deficiency is determined to exist, determining a position of the deficiency based on the position information, and
correlating the position of the deficiency with the examination data used for determining that the deficiency in the object exists.

12. An method of encoding examination data of an metallic object, the method comprising:
sensing a three-dimensional position of a plurality of targets, the targets being attached to an inspection system;
receiving examination data of the object, the examination data being obtained from the inspection system, the inspection system obtaining the examination data by performing an examination of the object, the examination including translation of the inspection system across the object;
encoding examination data, the encoding including,
determining position information of the inspection system relative to an origin point associated with the object,
the determining including detecting a change in position of the inspection system relative to the origin point using the sensed three-dimensional position of each of the targets, and
correlating the position information with the examination data.

13. The method of claim 12, wherein the method further comprises:
sensing an orientation of the targets, and
the encoding further includes,
determining orientation information of the inspection system based on the sensed orientation of the targets, and
correlating the orientation information with the examination data.

14. The method of claim 12, wherein the encoding further comprises:
determining a starting position of the inspection system based on a desired three-dimensional (3D) plane, the 3D plane being based on at least one criterion of the object; and
defining the origin point for performing the examination of the object based on the starting position, the origin point being a first examination point, the first examination point being a first position at which the inspection system obtains the examination data.

15. The method of claim 14, wherein determining the starting position comprises:
scanning a desired portion of the object;
defining a plane based on scanned portion; and
determining an axis of the starting position based on the plane.

16. The method of claim 15, wherein scanning the desired portion further comprises:
scanning at least three points on the object.

17. The method of claim 14, wherein the encoding further comprises:
determining the first examination point based on,
the starting position, and
a distance between the targets and a portion of the inspection system where the first examination data is being obtained while the inspection system is in the starting position; and
correlating a first position of the first examination point with the obtained first examination data.

18. The method of claim 17, wherein the encoding further comprises:
determining a change in a position of the inspection system due to the inspection system being placed in a second position, the second position being a different position than the starting position.

19. The method of claim 18, wherein the encoding further comprises:
determining a second examination point based on,
the second position, and
a distance between the targets and the portion of the inspection system where the examination data is being obtained while the inspection system is in the second position; and
correlating a second position of the second examination point with the obtained second examination data.

20. The method of claim 17, wherein the targets includes at least three markers, the 3D plane is defined using the at least three markers, and the sensing is performed by a camera system that includes at least two cameras, and wherein,
defining the origin point is further based on at least one point of the 3D plane, and
determining the first examination point is based on a distance between at least one marker of the at least three markers and the portion of the inspection system where the examination data is being obtained.

21. The method of claim 20, wherein,
the examination is performed by using at least one of an ultrasonic testing, an eddy current testing, and a phased array testing, and
the at least two cameras are infrared cameras.

22. The method of claim 12, wherein the encoding further comprises:
determining whether a deficiency in the object exists based on the examination data,
if the deficiency is determined to exist, determining a position of the deficiency based on the position information, and
correlating the position of the deficiency with the examination data used for determining that the deficiency in the object exists.

23. An inspection system for performing an examination of a metallic object and generating examination data to be encoded, the inspection system comprising:
a transducer configured to perform the examination of the object;
a transceiver configured to transmit the examination data, the examination data being based on the performed examination, the performed examination including translation of the inspection system across the object; and
a plurality of targets attached to the inspection system, a three-dimensional position of the targets being sensed by a camera system, the camera system being associated with a computing system,
the computing system configured to encode the examination data by,
determining position information of the inspection system relative to an origin point associated with the object,
the determining including detecting a change in position of the inspection system relative to the origin point using the sensed three-dimensional position of each of the targets, and
correlating the position information with the examination data.

24. A system for encoding examination data of a metallic object, the system comprising:
an inspection system including a plurality of targets attached to the inspection system, the inspection system configured to,
perform an examination of the object, the examination including translation of the inspection system across the object,
transmit examination data, the examination data being based on the performed examination; and
a computing system including a camera system and a processor,
the camera system configured to sense a three-dimensional position of the targets,
the processor configured to encode the examination data, and
the processor is configured to perform the encoding by,
determining position information of the inspection system relative to an origin point associated with the object,
the determining including detecting a change in position of the inspection system relative to the origin point using the sensed three-dimensional position of each of the targets, and correlating the position information with the examination data.
